(19) United States
(12) Patent Application Publication
(10) Pub. No.: US 2021/0145085 A1
(43) Pub. Date: May 20, 2021

(54) Apparatus For The Application Of A Fluid Material To A Garment

(71) Applicant: Supercrease Limited, Leeds, Yorkshire (GB)

(72) Inventors: Kenneth Houlbrook, Leeds, Yorkshire (GB); Shaun Carter, Leeds, Yorkshire (GB)

(21) Appl. No.: 16/617,278

(22) PCT Filed: Apr. 5, 2019
(86) PCT No.: PCT/GB2019/050999

§ 371 Date: Nov. 26, 2019

(30) Foreign Application Priority Data
Apr. 6, 2018 (GB) 1805761.2

(51) Int. Cl. A41D 1/10; A41H 43/00; A41D 27/24

(52) U.S. Cl. CPC A41D 1/10; B05C 17/00596; A41D 27/245; A41H 43/00

(57) ABSTRACT

An apparatus for use in the application of one or more lines of a fluid resin material onto crease lines of a garment to maintain the crease therein. The resin is typically applied from a cartridge as the cartridge is moved along the crease line. Apparatus is provided to support the garment with the crease line in position along a groove formed in the apparatus to allow the accurate location of the line of fluid resin material. The groove is formed along a face of one or more bodies of the support apparatus and the at least one groove is located at a spaced distance from a surface on which the apparatus is mounted for use and with which the at least one body contacts via one or more contact portions formed as part of, or connected to, the said at least one body. In one embodiment the support apparatus includes at least two bodies which are located at a spaced distance apart and in a substantially parallel relationship.

The invention to which this application relates is apparatus which is provided for use in the application of a fluid material, typically a resin like material, to a garment and, more particularly, the application of a relatively thin line or ribbon of the fluid material along a crease line in the garment so as to allow, when the fluid material has hardened, the crease to be retained in the garment for a longer period of time than would be the case if the fluid material was not present.

The provision of apparatus for this purpose is known and has been in use for a considerable period of time. Conventionally, there is provided a reservoir of the resin material which is held in a cavity in the cartridge and the cartridge has a dispensing nozzle with a slot and aperture through which a quantity of the fluid material can be progressively dispensed to form the ribbon material along the crease line. Relative movement between the cartridge and the garment along the line of the crease allows the ribbon of fluid material to be dispensed therealong. Typically, the cartridge is moved with respect to the garment, and the garment and crease line is located on a support surface which includes a groove formed in the same and into which the crease is placed so that the resin is applied to the inner surface of the garment which is exposed and thereby along the inner surface of the crease line so that the fluid material is applied to the base of the V—or gull winged shaped crease and then hardens so as to retain the shape of the crease and hence retain the crease in the garment.

The garment and support surface are typically provided at a height so as to allow the cartridge container to be gripped by the hand of a user and the user can then guide and move the cartridge along the crease line. The cartridge will typically include guide means formed therewith or mounted therewith. In one embodiment the guide means are in the form of one or more fins, which can be provided as part of the cartridge and/or may be provided on mounting means for the cartridge and the fins are typically located along a common axis and provided to be positioned and moved by sliding along the crease line in advance of the application of the fluid material.

The fluid material in the reservoir is moved towards the dispensing nozzle under pressure in order to force the resin through the slot and, in one embodiment, this is achieved by the provision of a piston within the cartridge which is provided to be moved from the end of the cartridge opposing the end at which the nozzle is provided and progressively towards the end with the nozzle so as to pass along the cavity and cause the flow of fluid material through the dispensing slot progressively. In order to move the piston, a pressurised airflow is connected to the cartridge so that pressurised air, when it enters the cartridge, serves to move the piston and hence the fluid material.

Conventionally, the control of the pressurised air supply is achieved via a foot pedal which is connected to pneumatic control means such that when the user operates the foot pedal, the pressurised air is supplied into the cartridge. Alternatively, as defined in the applicant's co-pending application, actuable control means user can be provided at, or adjacent to, the cartridge to allow the hand control of the air supply.

The support apparatus is conventionally provided as part of a stand which comprises a base with feet in contact with a support, such as a floor or table, one or more legs which extend upwardly from the base and, at a location spaced from the base, there is provided one or more support arms which extends from the legs and lie in a substantially horizontal plane. The arm typically has a free end which allows, for example, a leg portion of a garment which has been placed inside out so as to expose the internal surface of the leg portion, to be placed onto the free end and extended along at least part of the length of the arm, so that the arm lies inside the leg portion and the crease line to which the resin is to be applied is positioned along a groove formed along the arm. With the crease line in position, the same is retained in position by the groove and support arm the ribbon of fluid material can then be applied from the cartridge along the crease line. It will be appreciated that as the arm extends horizontally from one end from the leg, the base, legs and location means for the arm are required to be relatively strong and rigid in order to maintain the arm in the required position and, as such, this can lead to the apparatus being relatively bulky and expensive to manufacture and supply to the end user. It is found that these issues can mean that the conventional form of the apparatus can take up a significant amount of space, which may be at a premium in certain environments and/or may not be affordable or justifiable for relatively small scale usage. As such, the potential benefit of the use of the apparatus and to the finished garments is not fully commercially exploited.

An aim of the present invention is therefore to provide an improvement to the apparatus for use in the application of resin to a crease line of a garment. A further aim is to provide the support apparatus in a form which allows the same to be adaptable and to be more easily accommodated and used in relatively confined spaces and therefore increase the possibilities of practical use of the apparatus.

In a first aspect of the invention there is provided apparatus for use with a garment which has one or more crease lines along which a fluid material is to be applied, said apparatus including at least one body having at least one groove formed along a face of the same and wherein the said at least one groove is located at a spaced distance from a surface on which the apparatus is mounted for use and with which the at least one body contacts via one or more contact portions formed as part of, or connected to, the said at least one body.

In one embodiment the support apparatus includes at least two bodies which are located at a spaced distance apart.

In one embodiment the said bodies are substantially parallel along their respective longitudinal axes.

In one embodiment one or more retaining members are provided to maintain the bodies in the spaced part relationship.

In one embodiment the retaining members are located at or adjacent to one end of the said bodies and the opposing ends of the said bodies are free ends to allow a garment to be introduced onto and removed from the said bodies.

In one embodiment each of the bodies has at least one groove located there along and the bodies are located such that the grooves are substantially parallel and lie in the same plane.

In one embodiment the said bodies are provided to allow the simultaneous application of lines of fluid material to the garment at a spaced distance apart.

In one embodiment, a first set of one or more contact portions is provided at, or adjacent to, a first end of the body and a second set of one or more contact portions is provided at, or adjacent to, an opposing end of said body.

Typically a gap is defined between said sets of contact portions, the underside of the body and the surface on which the apparatus is mounted.

Typically the one or more faces of the apparatus on which a groove is formed are substantially parallel with the surface when the apparatus is located on the same for use.

In one embodiment, the body is provided to receive a portion of a garment therealong with a crease line of the garment positioned along the groove.

In one embodiment at least one set of contact portions are movable with respect to the body, said movement provided to improve the ease of placement and/or removal of the garment onto and from the body and/or to allow the body to be reversible in use.

In one embodiment the garment and body are relatively movable and/or are movable together about the longitudinal axis of the body between applications of ribbons of the fluid material. Typically therefore, in this embodiment, a first crease line of the garment is placed along the groove and a resin is applied therealong and when completed, movement between, or of, the garment and the body allows a further crease line of the garment to be placed along the same groove or a second groove of the arm, depending on the movement which is made, and a ribbon of fluid material is applied along the second crease line. This allows, for example, two crease lines of a trouser leg to have resin applied therealong without needing to wholly remove the trouser leg from the body in between the application of the fluid material along the first crease line and the fluid material along the second crease line and therefore provides a more efficient use of the apparatus, with an increased garment throughput rate.

In one embodiment, the garment is rotated relative to the body to change the particular crease line which is to be positioned on the groove to receive the fluid material therealong.

In an alternative embodiment, the body includes a groove provided along a first side of the body and a second groove formed along a further side of the body and the body and garment are rotated together so as to position the required groove and crease line for the application of the fluid material therealong.

In one embodiment, at least one set of contact portions include feet which protrude from the body in a first direction and feet which protrude from the body in a second direction, typically 180 degrees offset to the first direction. Typically those feet which protrude in the first direction protrude from a first side in which a groove is formed and the feet which protrude in the second direction protrude from the side of the body in which the second groove is formed.

Typically at least one contact portion in at least one set locates with a surface in the form of a table top. More typically at least one contact portion in each set contacts with the said table top.

In one embodiment a set of contact portions engage with a surface in the form of a bracket which may be placed on a surface such as a table top or attached to a side support such as to be wall mounted.

In one embodiment the support apparatus includes at least two bodies and the bodies are located together and retained at a spaced distance apart by retaining members. Typically each of the bodies has at least one groove located therealong and the bodies are located such that the grooves are substantially parallel and lie in the same plane. Typically there is provided a gap between said bodies, and hence between said grooves, and said gap extends from the retaining members located at, or adjacent to, one end of the bodies towards the respect opposing free ends of said bodies. In this form the apparatus is provided to allow the application of resin from two cartridges simultaneously with a ribbon of fluid material being positioned with respect to a first groove and a second ribbon of fluid material positioned with respect to a second groove.

In one embodiment the fluid material is applied from one or more cartridges, each having a dispensing nozzle connected to a reservoir in which the fluid material is located, and movement means are provided in the reservoir which, when actuated, move the fluid material towards the nozzle. Typically the actuation is achieved via a foot pedal or via hand operated actuation means.

In one embodiment, the said user actuation means are provided in the form of a switch operable by a user prior to, during and/or after moving the cartridge with respect to the garment or when the garment is moved with respect to the cartridge.

Typically, the user operation of the actuation means allows the switching on or off of the pressurised fluid source, such as an air pump, to the cartridge.

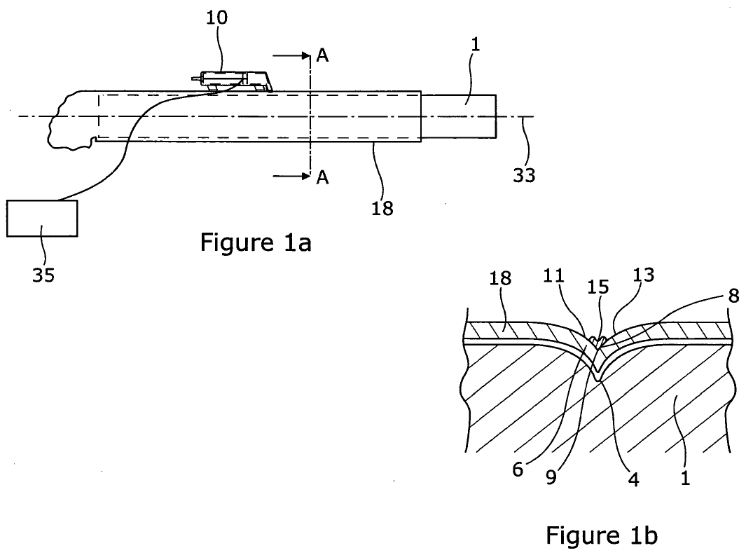

FIGS. 1a and b illustrate, schematically, apparatus in accordance with one embodiment of the invention;

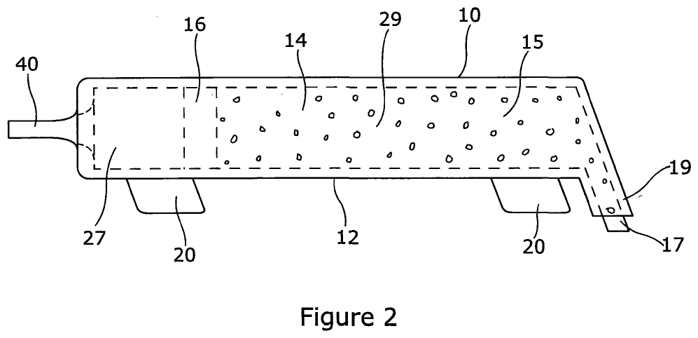

FIG. 2 illustrates a cartridge in accordance with one embodiment of the invention;

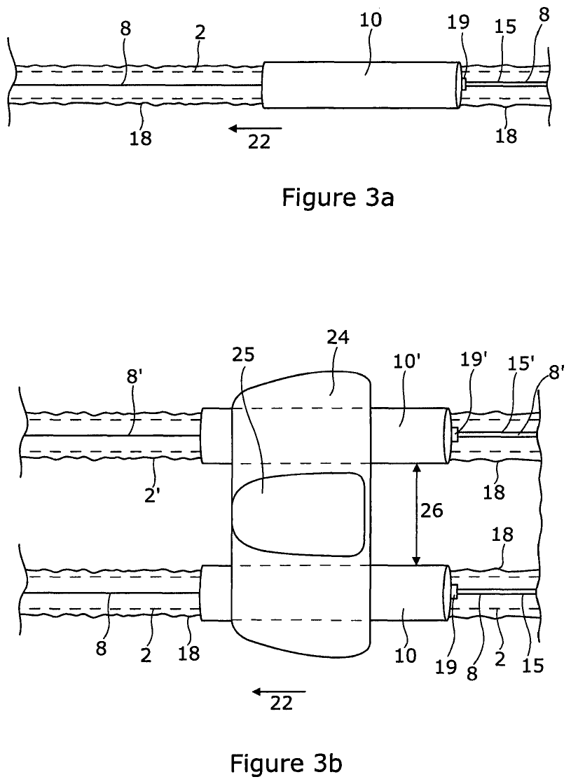

FIGS. 3a and b illustrate two embodiments of use of the cartridge in plan;

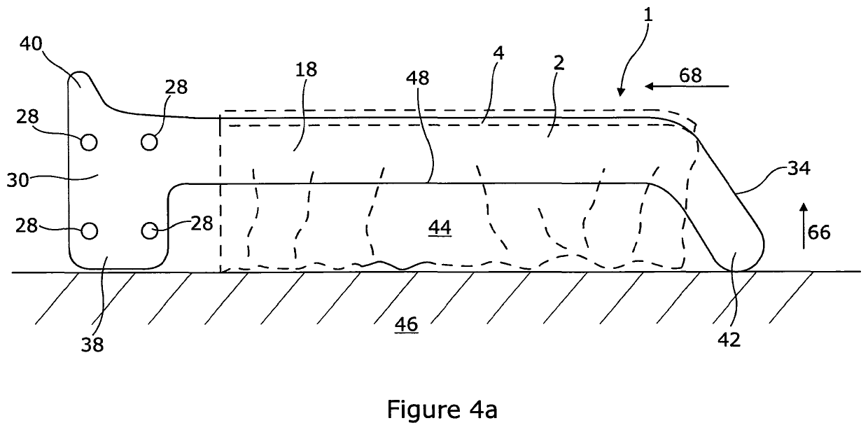

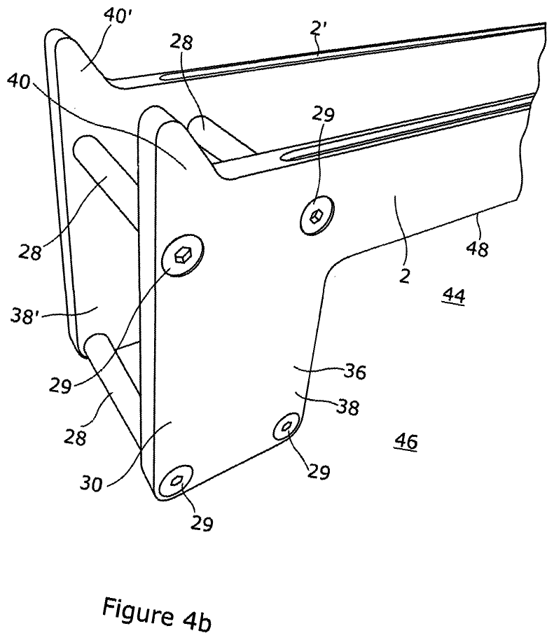

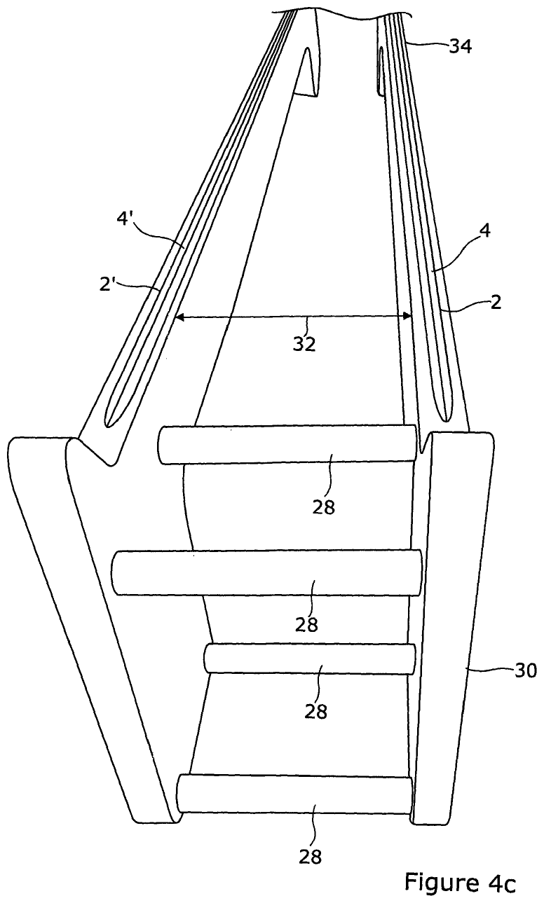

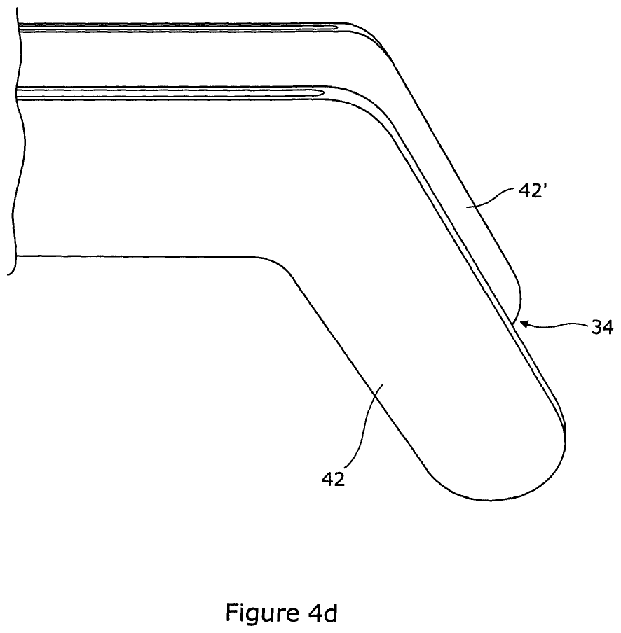

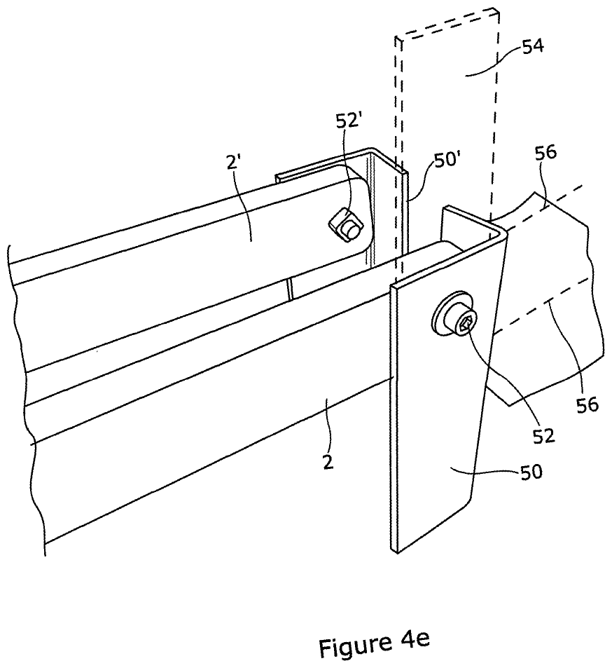

FIGS. 4a-e illustrates an embodiment of support apparatus in accordance with the invention;

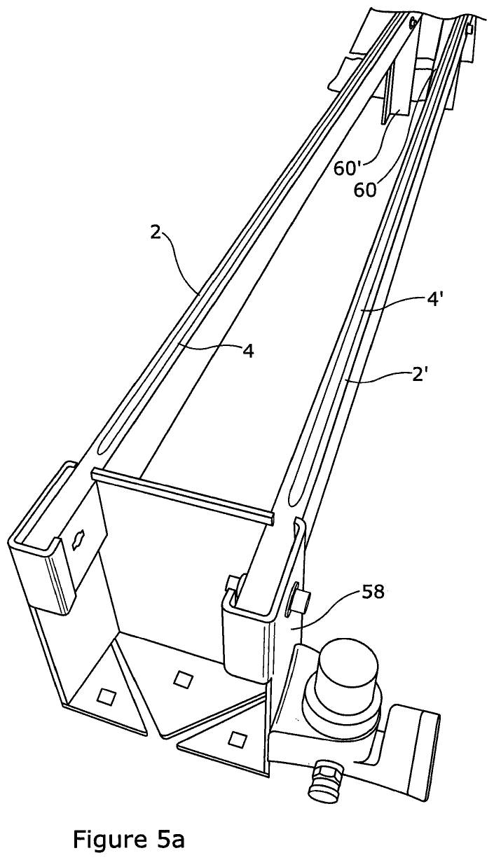

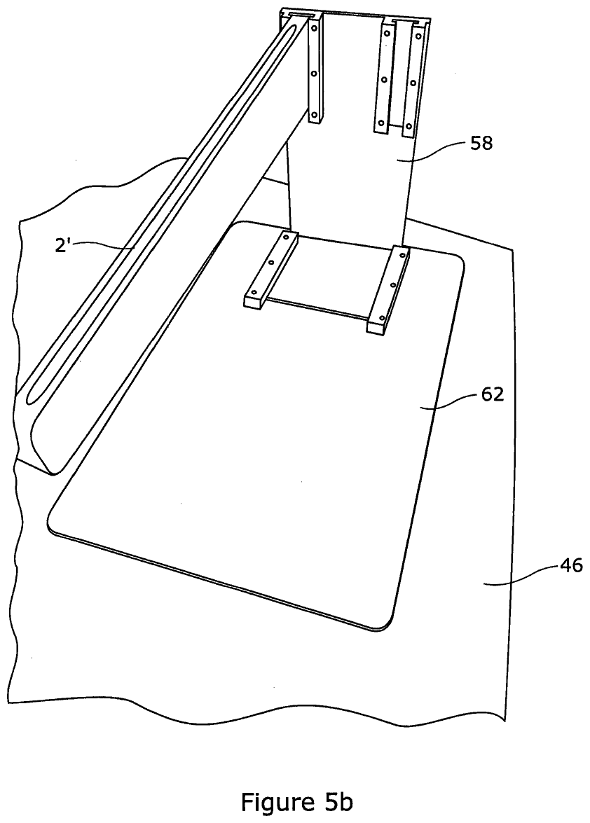

FIGS. 5a-c illustrate a further embodiment of support apparatus in accordance with the invention;

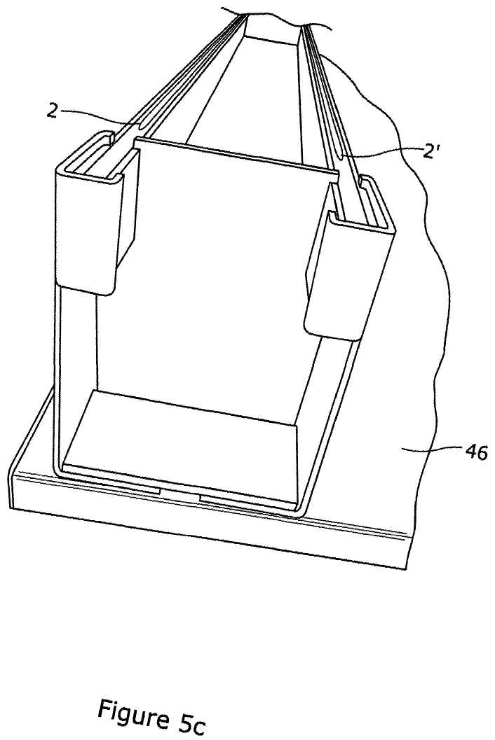

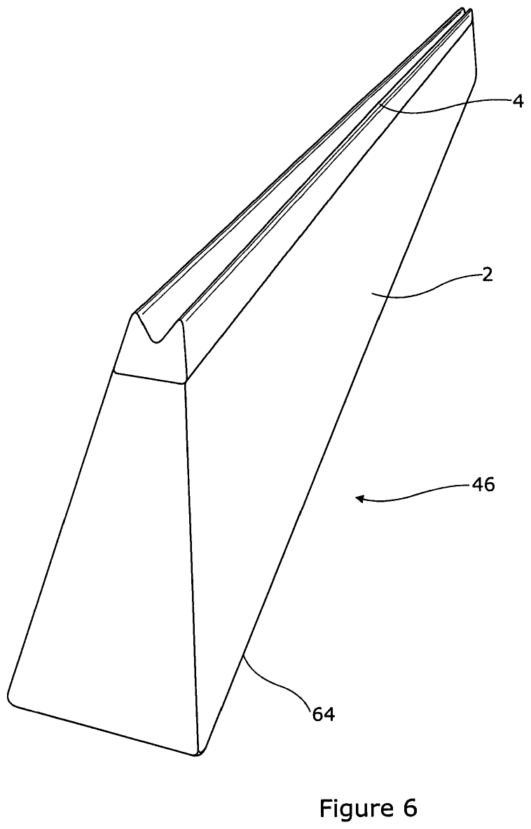

FIG. 6 illustrates a third embodiment of support apparatus in accordance with the invention; and

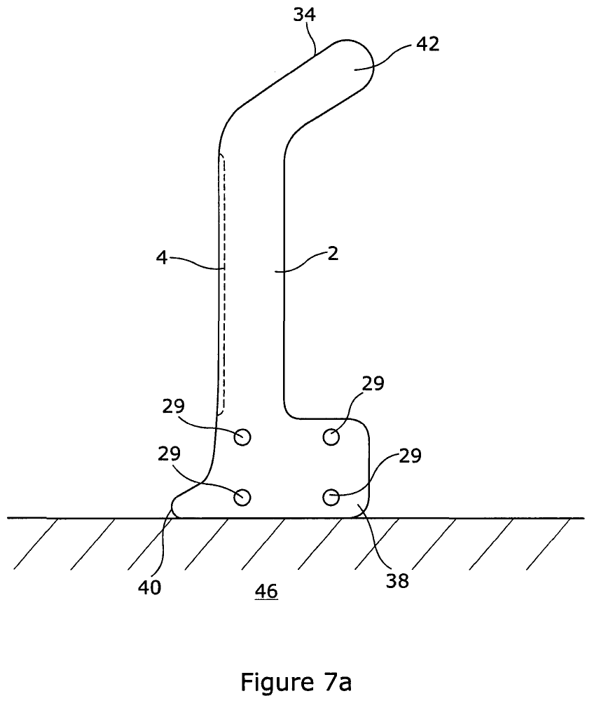

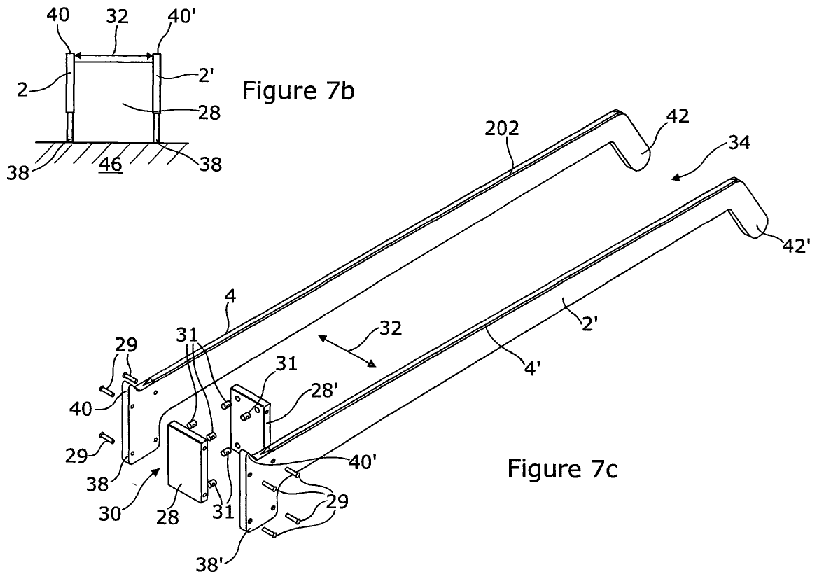

FIGS. 7a-c illustrate a support of the apparatus in accordance with one embodiment.

Referring firstly to FIGS. 1a and b there is illustrated, in schematic form, components of the apparatus which are provided in accordance with one embodiment of the current invention. The components include a support surface or table 1 which has at least one groove 4 formed along at least a portion thereof. The groove can be V-shaped or gullwing-shaped 6, as illustrated in FIG. 1b, in cross-section and is provided, in use, to receive a crease line 8 of a garment 18 therealong. The crease line has a base 9 and side walls 11,13, as illustrated in FIG. 1b, which is a cross section along line A-A of the table and into and along the base 9 of the crease line 8, a fluid resin material 15 is applied to retain the shape of the crease when the resin material subsequently hardens.

The fluid resin material is dispensed from a cartridge 10 which is shown in more detail in FIG. 2. The cartridge has a body 12 in which there is formed a reservoir 14 in which the fluid resin material 15 is provided and a movement means, in the form of a piston 16 is provided to be moved linearly along the interior of the cartridge body to encourage the fluid resin material to flow towards a dispensing nozzle 18 which has a dispensing aperture 17 through which the fluid resin material 15 flows to leave the cartridge and to be applied onto and along the garment crease line, typically at the same time as the cartridge is moved along the crease line so as to form a ribbon or line of the fluid resin material therealong. The fluid resin material is moved out of the cartridge through the aperture 17 under the influence of the piston 16 located in the cavity as the piston is moved by the provision of pressurised air from a source such as an air pump 35 which enters into the cavity to one side 27 of the piston, with the fluid resin material 15 being located on the other side 29 of the piston and at the end of which side the dispensing aperture 17 is located. Thus, the appropriate pressure of the pressurised air, in combination with the movement of the cartridge along the crease line allows the fluid resin material 15 to be applied from the aperture 17 onto the crease line in the required amount.

The cartridge movement along the crease line is guided by guide means 20 on or located with the cartridge and the guide means are moved along the crease line in the garment in advance of the aperture 17 as the cartridge is moved therealong and the groove 4 on the support 1 further guides the cartridge therealong so that the application of the fluid resin material is along the base 9 of the crease line.

FIG. 3a illustrates a first arrangement of use of a cartridge 10 of the type as described and there is again shown a support 2 with a crease receiving groove 4. The crease line 8 of the garment 18 is shown and the garment has been placed onto the body 2 such that the crease line 8 lies along the groove 4 formed in the body 2. The cartridge 10 is then moved along the crease line 8 in the direction indicated by arrow 22 and a ribbon of the fluid material 15 is dispensed from the dispensing nozzle 19 of the cartridge which is positioned such that the fluid material ribbon 15 is in line with the crease line 8 and so lies along the base of the crease line 8, as illustrated, to provide the required enhancement of the crease in the garment.

It will be appreciated that the groove 6 is substantially parallel with the longitudinal axis 33 of the support 1.

FIG. 3b illustrates an alternative embodiment in which there are provided two cartridges, 10, 10′ which are located by a mounting means 24 at a distance apart 26 and with the longitudinal axes of the same held substantially parallel so that the ribbons of fluid resin material 15, 15′ dispensed from the respective cartridges, 10, 10′ are substantially in parallel along the respective crease lines 8, 8′ of the garment 18. The distance apart 26 can be fixed or, alternatively, adjustable location means can be provided to allow the user to adjust the distance for particular use and/or ease of use. Most typically, the two crease lines 8, 8′ are formed on respective legs of the garment such as a pair of trousers. It will therefore be appreciated that by using the apparatus in accordance with FIG. 3b, two ribbons of fluid material 15, 15′, can be applied simultaneously.

In one embodiment the operation of the pressurised air source such as the air pump 35 is controlled via user actuable control means such as an air or electrical switch which, preferably is operable by a hand of the user and further preferably by the same hand which is sued to move the cartridge along the crease line and in one embodiment this can be achieved by providing the user actuable control means as part of the mounting means 24 and possibly as part of a movable gripping portion 25 of the mounting means so that the movement of the gripping portion by the user also operated the switch of the user actuable control means.

In both the arrangements of FIGS. 3a and 3b, it will be appreciated that there is always provided a support 1 with a groove 4 formed therein and on which the garments are located and which provide a surface along which the cartridges can be pressed and moved as the fluid resin material is dispensed therefrom.

Turning now to FIGS. 4a to d and FIGS. 7a-c, there is illustrated an embodiment of support apparatus 1 in accordance with the invention. In this embodiment, there are provided first and second bodies, 2, 2′, each having a groove line 4, 4′, formed therealong and the groove lines are substantially parallel and lie in the same plane. The bodies, 2, 2′, are retained in a spaced relationship by retention members 28, 28′ which can be bars as shown in FIGS. 4a-d or panels as illustrated in FIGS. 7a-c. The retention members are held in position by bolts 29 and location means 31 so as to retain the bodies 2, 2′, in a fixed relationship and the retaining members 28, 28′ are located at a first end 30 of the support apparatus 2. This therefore defines a gap 32 between the bodies when the same are fixed together, which extends from the retention members 28, 28′ uniformly towards the opposing end 34 of the support apparatus. The bodies, 2, 2′ have free ends at the end 34 and thereby form arms which allow the garment portions to be placed over and along the respective bodies 2, 2′ from the end 34 and moved along to extend towards the end 30 of the support apparatus, with the respective creases to which the fluid resin material is to be applied located in the grooves 4, 4′ formed on the top surfaces of the respective bodies 2,2′ and which extend at least partially along the same respectively.

Also provided, at each end 30, 34 of the support apparatus are first and second sets of support portions. The first set, 36 comprise first and second feet 38, 38′ of a first size and second feet portions 40, 40′ which is this embodiment are of a smaller size and which, in one embodiment, primarily act as stops for the garment. In one embodiment the portions 40, 40′ can also act as supports when the table is not in use to save space and for storage purposes in which the bodies 2, 2′ extend vertically upwardly from the support base 46, such as a table top or floor 46 as shown in FIG. 7a, on which the same is located, as opposed to extending horizontally when the apparatus is in use and as shown in the other Figures.

At the end 34, there is provided a second set of support portions which include first and second feet 42, 42′ which extend downwardly in the same direction as the feet 38, 38′ and thereby define a gap 44 between the support base 46 which in this case is a table top, the feet 38, 38′ and 42, 42′ and the underside 48 of the bodies 2, 2′, intermediate the said feet.

In FIG. 4a there is illustrated in broken lines a garment 18 which is positioned along one of the bodies 2 for ease of illustration and the crease line in the garment is located along the groove 4 of the body. The remainder of the garment 18 falls down onto the support surface 46 and therefore takes up the position shown, for example, in FIG. 3a to allow the cartridges to then be moved along the same to deposit the fluid resin material as previously described.

The garment 18 is introduced onto the body by first raising the contact feet 42 in the direction of arrow 66 and the open end of the garment is then slid onto the body 2 and then moved along the same as indicated by arrow 68 until the garment is in position along the groove. The garment can then be rotated around the body longitudinal axis so as to position the crease line of the garment into the groove 4 of the body so that the same is correctly positioned for the application of the fluid resin material therealong. Once the resin material has been applied and at least partially hardened the garment can be slid off the body if there are no further lines of fluid resin material to be applied, or alternatively the garment can be rotated around the body 2 longitudinal axis with the same lying in the gap 44 as shown, so as to position a further crease line in the groove for the application of a line of the fluid resin material therealong.

FIG. 4e illustrates an alternative form of support portions which can be used to replace the fixed feet, 42 for example in FIGS. 4a, and 4d. In this case, the feet 50, 50′, are pivotally moveable about pivot locations 52, 52′ respectively so as to allow the feet to lie in a position depending downwardly from the body portions 2, 2′ in a position shown or, alternatively, can be turned through 90 or 180 degrees about the pivot locations 52, 52′ to extend in the opposite direction as indicated in broken lines with respect to portion 54 in which the case the bodies can be reversed or could be moved 90 degrees to the position indicated by 56 so as to allow the improved movement of the garment onto and from the bodies.

Referring now to FIGS. 5a to 5c, there is illustrated a further embodiment of the support apparatus including bodies 2 2′ with respective grooves 4, 4′ formed therealong and first support portions in this case in the form of a bracket 58 at one end and support portions 60, 60′ at the opposing end. In this case, the bodies 2, 2′, are selectively removable from the bracket 58 as illustrated in FIG. 5b in which only the body 2′ is shown in position. The bracket may be attached to a wall or is provided, as in this embodiment, with a plate 62 which can be positioned onto a table top 46 as shown in FIG. 5b.

Thus, in this embodiment, the apparatus is adaptable so as to provide, in the arrangement as shown in FIGS. 5a and 5c, apparatus which can be used in conjunction with a double cartridge 10, 10′ arrangement of a type shown in FIG. 3b or can be provided in the form shown in FIG. 5b in which the same can be used with a single cartridge application of the type shown in FIG. 3a.

A further embodiment of the invention is illustrated in FIG. 6 in which case there is provided a body 2 which is a unitary member provided with a support portion 64 which is provided for contact with a surface in the form of a table top 46 and has an opposing surface in which the groove 4 is provided.

It will therefore be appreciated that in each of the embodiments, the same can be formed of a suitable material which could be wood, aluminium or a material known as trespa. Typically, the support, possibly in the form of a table top, in addition to providing support for the apparatus, also acts to provide support for the garment 18 so that the garment is not entirely hanging down under its own weight from the body when the crease line 8 is positioned in the groove 4. Furthermore, it will be appreciated that relative rotational movement of the garment with respect to the body allows different crease lines of the garment to be brought into contact with a particular groove in the body so as to allow more than one ribbon of fluid material to be applied without having to entirely remove the garment from the body. In another embodiment, the body may be provided with first and second groove lines on different sides so as to allow the body and the garment to be rotated so as to allow different crease lines to be positioned with different grooves in the body and hence once more, a number of ribbons of the fluid material can be applied along respective crease lines without having to entirely remove the garment from the body.

1. Apparatus for use with a garment which has one or more crease lines along which a fluid material is to be applied, said apparatus including at least one body having at least one groove formed along a face of the same and wherein the said at least one groove is located at a spaced distance from a surface on which the apparatus is mounted for use and with which the at least one body contacts via one or more contact portions formed as part of, or connected to, the said at least one body.

2. Apparatus according to claim 1 wherein the support apparatus includes at least two said bodies which are located at a spaced distance apart.

3. Apparatus according to claim 1 wherein the said bodies are substantially parallel along their respective longitudinal axes.

4. Apparatus according to claim 2 wherein one or more retaining members are provided to maintain the said bodies in the spaced part relationship.

5. Apparatus according to claim 4 wherein the retaining members are located at or adjacent to one end of the said bodies and the opposing ends of the said bodies are free ends to allow a garment to be introduced onto and removed from the said bodies.

6. Apparatus according to claim 2 wherein each of the bodies has at least one groove located there along and the bodies are located such that the grooves are substantially parallel and lie in the same plane.

7. Apparatus according to claim 2 wherein the said bodies are provided to allow the simultaneous application of lines of fluid material to the garment at a spaced distance apart.

8. Apparatus according to claim 1 wherein a first set of one or more contact portions is provided at, or adjacent to, a first end of the said body and a second set of one or more contact portions is provided at, or adjacent to, an opposing end of said body.

9. Apparatus according to claim 8 wherein a gap is defined between said sets of contact portions, the underside of the body and the surface on which the apparatus is mounted.

10. Apparatus according to claim 6 wherein the said grooves are substantially parallel with the surface when the apparatus is located on the same for use.

11. Apparatus according to claim 6 wherein each body is provided to receive a portion of a garment there along with a crease line of the garment positioned along the at least one groove on the said body

12. Apparatus according to claim 8 wherein at least one set of contact portions are moveable with respect to the body, in order to ease placement and/or removal of the garment onto and from the body and/or to allow the body to be reversable in use.

13. Apparatus according to claim 1 wherein the garment and body are relatively moveable about the longitudinal axis of the body between the applications of lines of the fluid material along crease lines of the garment.

14. Apparatus according to claim 6 wherein a first crease line of the garment is placed along the groove and a line of the fluid material is applied there along and, when completed, movement between the garment and the body allows a further crease line of the garment to be placed along the same groove or a second groove, and a line of fluid material is applied along the second crease line.

15. Apparatus according to claim 13 wherein lines of fluid material are applied along respective crease lines of the same garment without having to wholly remove the garment from the body.

16. Apparatus according to claim 14 wherein the garment is rotated relative to the body to select a particular crease line which is positioned on the groove formed on the body.

17. Apparatus according to claim 1 wherein the body includes a groove provided along a first side of the body and a second groove formed along a further side of the body and the body and garment are rotated together so as to position the required groove and crease line for the application of a line of the resin there along.

18. Apparatus according to claim 8 wherein at least one of the set of contact portions include feet which protrude from the body in a first direction and feet which protrude from the body in a second direction and said feet are usable to support the apparatus in a storage position.

19. Apparatus according to claim 18 wherein the said first and second directions are offset by substantially 180°.

20. Apparatus according to claim 1 wherein in a storage position the at least one body is located on a support surface with their longitudinal axes substantially perpendicular to the position of the longitudinal axes when the apparatus is in the in use position.

21. Apparatus according to claim 20 wherein only the feet of the set a contact portions contact with the surface to retain the apparatus in the storage position.

22. Apparatus according to claim 8 wherein a set of contact portions engage with a surface in the form of a bracket placed on a surface or attached to a side support so as to be wall mounted.

23. Apparatus according to claim 6 wherein the groove in cross section is formed of a shape which is substantially gull winged.
